(19) United States
(12) Patent Application Publication
(10) Pub. No.: US 2009/0066853 A1
(43) Pub. Date: Mar. 12, 2009

(54) REMOTE CONTROL WITH RECESSED KEYPAD

(75) Inventor: Tohru Doumuki, San Diego, CA (US)

Correspondence Address: ROGITZ & ASSOCIATES, 750 B STREET, SUITE 3120, SAN DIEGO, CA, 92101, US

(73) Assignee: Sony Corporation Sony Electronics Inc.

(21) Appl. No.: 11/852,603

(22) Filed: Sep. 10, 2007

(51) Int. Cl. H04N 5/44

(52) U.S. Cl. 348/734

(57) ABSTRACT

A TV remote control has a recessed keypad so that if the remote is laid face down the keys will not be activated by the weight of the remote.

### FIELD OF THE INVENTION

The present invention relates generally to TV remote controls with recessed keypads.

### BACKGROUND OF THE INVENTION

Touch pad remote controls have began replacing conventional push-button remote controllers in the marketplace. These touch pad remote controllers are manipulated through a physical contact with a user without the user having to actually apply ample pressure to push a button. Light physical contact with the touch pad is sufficient for the remote control to receive an input. Thus, the touch pads being implemented in remote controls are similar in function to the touch pads that have been implemented in laptop computers and many MP3 players.

However, even the slightest unintended contact with the touch pad of a remote control may be interpreted by the remote control as an intended command. Even placing a remote control with the touch pad facing down may cause an unintended command to be communicated to the system. These unintended commands may drain the battery life of the remote control and may also manipulate the system communicating with the remote control in an unintended manner. Thus, an increasing need to protect these touch pads from unintended contact has arisen.

### SUMMARY OF THE INVENTION

A remote control includes a plastic housing defining a top bounding surface and a bottom surface opposite the top bounding surface. The housing also defines a control region, and the top bounding surface substantially surrounds the control region. The control region is closer to the bottom surface than the top bounding region is to the bottom surface. Plural control keys are disposed on the control region, and the top bounding region does not bear any control keys. A processor is in the housing and receives input from the control keys. Also, a wireless transmitter is supported by the housing and receives input from the processor.

The preferred non-limiting control region is concave throughout its area relative to the top bounding surface. One control key may be located at the geometric center of the control region. It is to be appreciated that the top bounding surface can be laid against a support and that the control keys are recessed from the support such that the weight of the housing does not urge the keys against the support. In some embodiments the control keys are light-touch buttons arranged in a touch pad configuration that detect a direction of a finger as the finger slides over the keys.

In another aspect, a TV communicates with a remote control with a user-manipulable touch pad accessible from a top surface of the remote control and recessed therefrom, such that a user can manipulate the touch pad to send wireless commands to the TV and such that the remote control can be laid on the top surface and the touch pad is not contacted by a surface of which the top surface rests.

In still another aspect, a method includes providing a remote control, and configuring the remote control for wireless communication with a TV. The method also includes providing a user key array on the remote control to enable a user to manipulate the key array to send commands to the TV. The remote control is configured such that any portion of the remote control can be laid to rest on a surface without the key array touching the surface.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram showing the present remote control in conjunction with a TV;

FIG. 2 is a top plan view showing the remote control and corresponding GUI on the TV; and

FIG. 3 shows top plan, side elevational and end elevational views of the remote control.

### DETAILED DESCRIPTION OF THE PREFERRED EMBODIMENT

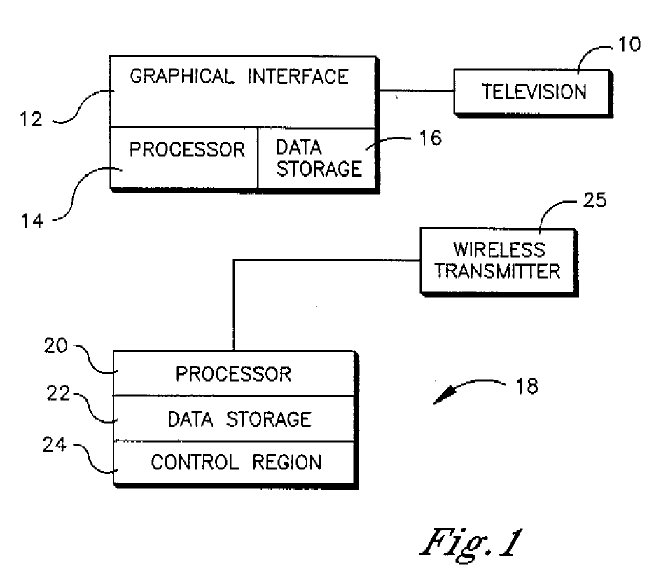

Beginning with FIG. 1, a system containing a remote control with a protected control region is shown. A television system 10 is shown, including a graphical interface 12 which is capable of displaying electronic images including, e.g., a television command menu, television subscription service guide, and other user-controlled electronic interfaces. The television system 10 also has a processor 14 capable of executing user commands and at least one data storage 16 which may store various, non-limiting types of data. The data storage 16 may hold information regarding, e.g., a user's favorite television channels or saved television programs recorded at a prior time.

FIG. 1 also shows a remote control 18 which is capable of electronic communication with the television system 10. The remote control 18 has a processor 20 capable of executing user commands input through control keys (not shown) on the remote control 18. The remote control 18 also has at least one data storage 22 which may store various, non-limiting types of data. The data storage 22 may hold information regarding, e.g., preset channel memory corresponding to particular buttons on the remote control 18.

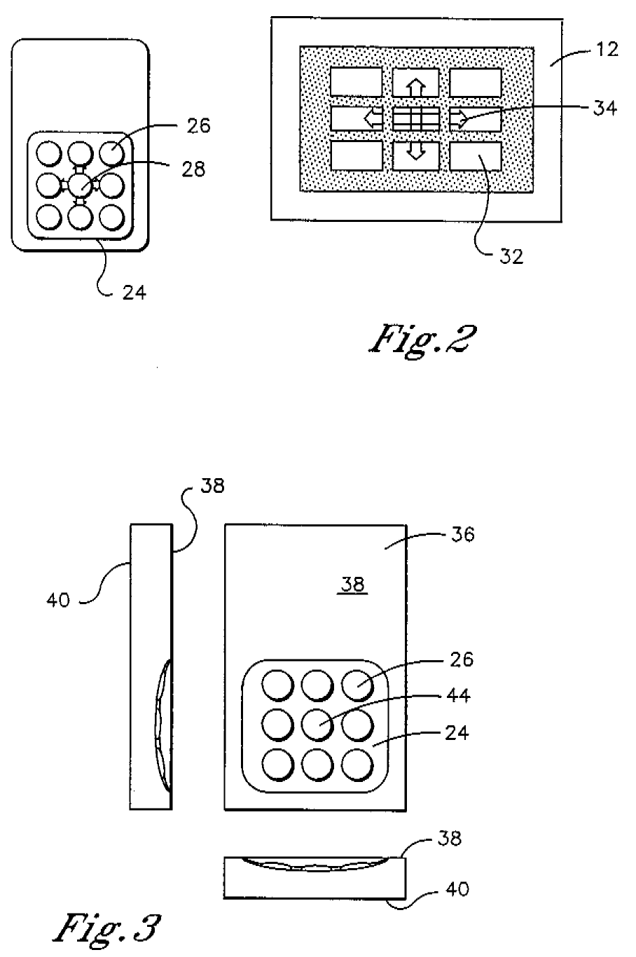

Also shown on the remote control 18 in FIG. 1 is a control region 24. The control region 24 receives input from a user through a “touch pad,” which will be discussed in greater detail in FIG. 2.

Additionally, the remote control 18 includes a wireless transmitter 25 which receives input from the processor 20. The wireless transmitter 25 is capable of producing a non-limiting electronic signal, such as an infrared signal, which allows it to communicate with the television system 10. In particular, the wireless transmitter 25 transmits user commands to the television system 10 that were input into the remote control 18.

FIG. 2 provides further illustration regarding the function of a sensitive touchpad in the control region 24. Rather than embodying conventional, independent push buttons common on many remote controls, the control region 24 provides input to the processor 20 through a sensitive touch pad.

The touch pad has one distinguishable area, with different sections of the area having light touch buttons. The light touch buttons receive their input by having slight pressure applied to the designated section of the touch pad.

The control region 24 has plural buttons 26 that are intended to send different commands to the processor 20. The direction arrows 36 further illustrate how a user may manipulate the touch pad 24, sliding a user's finger from one section to another without an interruption of physical contact with the control region 24.

A user interface 12 that can be present, e.g., on the screen of the television set, is also shown in FIG. 2. A user may manipulate the control region 24 without looking at the remote, instead looking at the effect the user's contact with the remote control 18 has on the user interface 12. Sectors 32 are shown in the user interface 12, with the sectors 32 corresponding to respective light touch buttons 26 on the control region 24 of the remote control. Direction arrows 34 further illustrate how the manipulations of the user may be represented on the user interface 12. Thus, a user may navigate through the user interface 12 without having to look at the remote control 18.

Moving to FIG. 3, details of the remove control 18 can be seen. The remote control includes a portable lightweight hand-held housing 36. The housing 36 has a flat top bounding surface 38 and a flat bottom bounding surface 40 opposite and parallel to the top bounding surface 38. Furthermore, the top bounding surface 38 does not bear any control keys.

Plural control key sections 26 are disposed within the control region 24, which, as shown, is recessed from the top surface 38. The control region 24 is defined by the housing 36 with the top bounding surface 38 substantially surrounding the control region 24. Further, the surface of the control region 24 may be recessed by virtue of being concave throughout its area relative to the top bounding surface 38, the control region 24 thus being closer to the bottom bounding surface 40 than the top bounding surface 38 is to the bottom bounding surface 40.

The recessed design of the control region 24 thus advantageously reduces the risk of unintended physical contact with a person or other object that would reduce the battery life of the remote control 18 or cause unintended commands to the sent to the system interacting with the remote control 18. For example, placing a remote control face down will advantageously not cause unintended contact to be interpreted by the processor 20, nor will it cause an unintended drain on the remote control's batteries, because the control keys in the control region 24 are recessed from the top surface 38 which rests on the table or other surface.

The side and bottom views also shown in FIG. 3 further illustrate the position of the control region 24 relative to the top bounding surface 38 and bottom bounding surface 40. While in actuality the housing would appear rectangular in shape in both the side and bottom views, the views shown in FIG. 3 are shown partially in phantom to further illustrate the recessed disposition of the control region 24 relative to the bounding surfaces.

Further still, a central control key 44 is shown in FIG. 3. The control key 44 is critically located at the geometric center of the control region 24. Thus, a user may utilize sense of touch to gain orientation on the control region 24, thereby identifying specific buttons without having to actually look at the control region 24.

While the particular REMOTE CONTROL WITH RECESSED KEYPAD is herein shown and described in detail, it is to be understood that the subject matter which is encompassed by the present invention is limited only by the claims.

What is claimed is:

1. A remote control comprising:
a plastic housing defining a top bounding surface and a bottom surface opposite the top bounding surface;
the housing also defining a control region, the top bounding surface substantially surrounding the control region, the control region being closer to the bottom surface than the top bounding region is to the bottom surface, plural control keys being disposed on the control region, the top bounding region not bearing any control keys;
a processor in the housing and receiving input from the control keys; and
a wireless transmitter supported by the housing and receiving input from the processor.

2. The remote control of claim 1, wherein the control region is concave throughout its area relative to the top bounding surface.

3. The remote control of claim 1, wherein one key is located at the geometric center of the control region.

4. The remote control of claim 1, wherein the top bounding surface can be laid against a support and the control keys are recessed from the support such that the weight of the housing does not urge the keys against the support.

5. The remote control of claim 1, wherein the control keys are light-touch buttons arranged in a touch pad configuration that detect a direction of a finger as the finger slides over the keys.

6. A systems, comprising:
a TV; and
a remote control with a user-manipulable touch pad accessible from a top surface of the remote control and recessed therefrom, such that a user can manipulate the touch pad to send wireless commands to the TV and such that the remote control can be laid on the top surface and the touch pad is not contacted by a surface of which the top surface rests.

7. The system of claim 6, wherein the remote control includes:
a plastic housing defining a top bounding surface and a bottom surface opposite the top bounding surface;
the housing also defining a control region, the top bounding surface substantially surrounding the control region, the control region being closer to the bottom surface than the top bounding region is to the bottom surface, the touch pad being disposed on the control region, the top bounding region not bearing any control keys;
a processor in the housing and receiving input from the touch pad; and
a wireless transmitter supported by the housing and receiving input from the processor.

8. The system of claim 7, wherein the control region is concave throughout its area relative to the top bounding surface.

9. The system of claim 7, wherein one key of the touch pad is located at the geometric center of the control region.

10. The system of claim 7, wherein the touch pad includes light-touch buttons that detect a direction of a finger as the finger slides over the pad.

11. A method, comprising:
providing a remote control;
configuring the remote control for wireless communication with a TV;
providing a user key array on the remote control to enable a user to manipulate the key array to send commands to the TV; and
configuring the remote control such that any portion of the remote control can be laid to rest on a surface without the key array touching the surface.

12. The method of claim 11, wherein the remote control includes:
a plastic housing defining a top bounding surface and a bottom surface opposite the top bounding surface;
the housing also defining a control region, the top bounding surface substantially surrounding the control region, the control region being closer to the bottom surface than the top bounding region is to the bottom surface, the key pad being disposed on the control region, the top bounding region not bearing any control keys;
a processor in the housing and receiving input from the key pad; and
a wireless transmitter supported by the housing and receiving input from the processor.

13. The method of claim 12, wherein the control region is concave throughout its area relative to the top bounding surface.

14. The method of claim 12, wherein one key of the key pad is located at the geometric center of the control region.

15. The method of claim 12, wherein the keypad includes light-touch buttons that detect a direction of a finger as the finger slides over the pad.
